(19) United States
(12) Patent Application Publication
(10) Pub. No.: US 2021/0246059 A1
(43) Pub. Date: Aug. 12, 2021

(54) ENERGY-SAVING SLUDGE DRYING DISPOSAL SYSTEM

(71) Applicants: GUANGDONG UNIVERSITY OF TECHNOLOGY, GUANGZHOU (CN); Guangzhou Herui Energy Conservation and Environmental Protection Technology Co., Ltd., GUANGZHOU (CN)

(72) Inventors: Xiaozhou LIU, GUANGZHOU (CN); Peibin LIN, GUANGZHOU (CN); Guangyu ZHU, GUANGZHOU (CN); Qinning MA, GUANGZHOU (CN); Yu ZHANG, GUANGZHOU (CN); Shuirun WEN, GUANGZHOU (CN)

(21) Appl. No.: 17/242,290

(22) Filed: Apr. 27, 2021

Related U.S. Application Data
(63) Continuation of application No. PCT/CN2020/106649, filed on Aug. 3, 2020.

(30) Foreign Application Priority Data
Dec. 23, 2019 (CN) 201911338636.6

(51) Int. Cl. C02F 11/13; F23G 7/00; F23G 5/44

(52) U.S. Cl. CPC C02F 11/13; F23G 7/001; F23G 5/44; F23G 2209/12; C02F 2209/03; C02F 2303/10; C02F 2209/02

(57) ABSTRACT

An energy-saving sludge drying disposal system is provided. The disposal system includes a vacuum heating unit, an incinerating unit, a vacuum cooling unit and a molten salt heat exchanging unit. The vacuum cooling unit includes a high-temperature gas inlet, a condensed water outlet, a low-temperature gas outlet, a low-temperature liquid inlet and a medium-temperature liquid outlet. The high-temperature gas inlet of the vacuum cooling unit is connected with the vacuum heating unit. The incinerating unit includes an incinerator, an incineration gas inlet, a combustion-supporting gas inlet, a flue gas discharge outlet, a cold molten salt inlet and a hot molten salt outlet. The incineration gas inlet is connected with the low-temperature gas outlet of the vacuum cooling unit. The molten salt heat exchanging unit includes a cold molten salt outlet, a hot molten salt inlet, a medium-temperature liquid inlet and a high-temperature liquid outlet.

### CROSS-REFERENCE TO RELATED APPLICATIONS

This application is a continuation of International Patent Application No. PCT/CN2020/106649 with a filing date of Aug. 3, 2020, designating the United States, now pending, and further claims priority to Chinese Patent Application No. 201911338636.6 with a filing date of Dec. 23, 2019. The content of the aforementioned applications, including any intervening amendments thereto, are incorporated herein by reference.

### TECHNICAL FIELD

The present disclosure relates to a sludge disposal system, and more specifically, to a sludge drying disposal system.

### BACKGROUND OF THE PRESENT INVENTION

Sludge is solid precipitated substances produced in a water and sewage disposal process, and may also be considered to be sediments, particles and floats produced when the waste water is treated by physical methods, chemical methods, physiochemical method, biological method, etc. The sludge is a kind of extremely complex inhomogeneous substance composed of organic residues, bacteria bodies, inorganic particles, colloids, etc. The sludge has the main characteristics of high water content (up to 99% or more), high content of organic matters, easy corruption and smelliness, small particle size, small specific gravity and colloidal liquid state.

In the existing sludge drying process, a direct contact area between the sludge and hot air is small, resulting in low drying speed of the sludge. Secondly, when the water in the sludge is evaporated, the evaporated vapor is directly discharged to the atmosphere, so that peculiar smell carried in the sludge causes a certain contamination of the air and moreover, a great amount of heat energy is wasted, and at the same time, great heat burden and harm are brought to the environment.

As disclosed in the Chinese patent application CN105645733A, a sludge drying and incinerating system and the corresponding incinerating process thereof are disclosed. The sludge drying and incinerating system includes a mud and ash mixer, a sludge granulator, a preheater, a sludge drying bed, a multi-section incinerator, a vapor-water separator and an exhaust gas purifying device. The mud and ash mixer is connected with the sludge granulator through a first sludge feeding device. The sludge granulator is connected with the preheater through a conveyor. The preheater is connected with the sludge drying bed successively through a second sludge feeding device and a sludge paving machine. The sludge drying bed is connected with the multi-section incinerator through a screw conveyer. A gas outlet of the multi-section incinerator is connected with a gas inlet of the preheater and a gas inlet of the sludge drying bed respectively through a pipeline. A gas outlet of the preheater and a gas outlet of the sludge drying bed are connected with a gas inlet of the vapor-water separator respectively through a pipeline. A gas outlet of the vapor-water separator is connected with a gas inlet of the multi-section incinerator and a gas inlet of the waste gas purifying device respectively through a pipeline. However, the sludge drying and incinerating system and the incinerating process thereof have the following disadvantages or defects: (1) the preheater and the sludge drying bed require a large amount of heat provided by the outside; and (2) waste heat utilization of the of the exhaust gas is not sufficient.

As also disclosed in Chinese patent application CN107162379A, a disc sludge drying system based on cascade utilization of energy is disclosed. The drying system includes a disc drying system and a filter-press drying system. The disc drying system includes a shell. A stirring shaft is installed in the shell, and discs are spaced on the stirring shaft. The top of the shell is provided with a sludge inlet and a steam outlet, and the bottom is provided with a dry sludge outlet. The stirring shaft is driven by a stirring motor at one end. The stirring shaft is of a hollow structure, one end of which is a hot vapor inlet with a condensed water outlet pipe plugged therein. The filter-press drying system includes a filter-press system, a sludge feeding system connected with the filter-press system, a vacuumizing system, a hot water circulating system and a sludge output system. The sludge feeding system is connected with a sludge inlet end of the filter-press system, and the sludge output system is connected with a sludge outlet end of the filter-press system. The vacuumizing system is used to keep the filter-press system in a negative pressure state when the sludge is filter-pressed, and the hot water circulating system is connected with a vapor outlet of the disc drying system. However, the disc sludge drying system based on the cascade utilization of energy has the following disadvantages or defects: (1) the disc drying system requires ultrahigh temperature hot steam to perform sludge drying, and the energy consumption is large when the sludge is dried; and (2) toxic and harmful gases in the waste gas discharged by the drying of the sludge are not separated effectively.

Therefore, it is an urgent problem in the industry to provide an energy-saving sludge drying disposal system capable of improving the drying degree of the sludge and effectively increasing the utilization rate of the waste heat energy.

### SUMMARY OF PRESENT UTILITY MODEL

A purpose of the present invention is to provide an energy-saving sludge drying disposal system, which can separate fully organic waste gases in evaporated vapor produced by the drying of sludge. The environmental pollution caused by the organic waste gases can be eliminated by burning and decomposing the organic waste gases; and moreover, by utilizing part of heat produced by the burning of the waste gases, part of the heat generated by burning waste gases can exchange heat with the low-temperature water produced by cooling the sludge. As a result, the cold water is heated up into hot water. Then the hot water is reused to dry the sludge at a low temperature and in a vacuum manner. At the same time, another part of energy may also be used to store the heat. The hot air produced by cooling the burned waste gases is further preheated to serve as a combustion-supporting gas to improve the burning effect of the waste gas.

To achieve the above purpose, the present invention provides an energy-saving sludge drying disposal system, which includes: a vacuum heating unit, an incinerating unit, a vacuum cooling unit and a molten salt heat exchanging unit. The vacuum cooling unit includes a cooling tank, a high-temperature gas inlet arranged at the top wall of the cooling tank, a condensed water outlet arranged at the bottom wall of the cooling tank, a low-temperature gas outlet and a low-temperature liquid inlet arranged at one side of the cooling tank, a medium-temperature liquid outlet arranged at the other side of the cooling tank, and a cooling pipe, whose two ends are respectively connected between the low temperature liquid inlet and the medium temperature liquid outlet, arranged in the cooling tank. The high-temperature gas inlet of the vacuum cooling unit is connected with a mixed gas outlet of the vacuum heating unit. The incinerating unit includes an incinerator, and an incineration gas inlet, a combustion-supporting gas inlet, a fuel inlet, a flue gas discharge outlet, a cold molten salt inlet and a hot molten salt outlet which are arranged in sequence on the wall of the incinerator, and a heating molten salt pipeline arranged in the incinerator and connected to the cold molten salt inlet and the hot molten salt outlet respectively at both ends. The incineration gas inlet is connected with the low-temperature gas outlet of the vacuum cooling unit. The molten salt heat exchanging unit includes a heat exchanger shell, and a cold molten salt outlet, a hot molten salt inlet, a medium-temperature liquid inlet and a high-temperature liquid outlet which are arranged on the heat exchanger shell, a heat exchanging molten salt pipeline arranged in the heat exchanger shell and connected between the cold molten salt outlet and the hot molten salt inlet at both ends, a heat exchanging water pipeline connected between the medium-temperature liquid inlet and the high-temperature liquid outlet at both ends, and an electric heating device arranged in the heat exchanger shell. The cold molten salt outlet is connected with the cold molten salt inlet of the incinerating unit, and the hot molten salt inlet is connected with the hot molten salt outlet of the incinerating unit. The medium-temperature liquid inlet is connected with the medium-temperature liquid outlet of the vacuum cooling unit, and the high-temperature liquid outlet is connected with the vacuum heating unit.

The electric heating device in the molten salt heat exchanging unit is started first to preheat molten salt in the heat exchanging molten salt pipeline, so that the molten salt is in a flowable state to enter the heating molten salt pipeline in the incinerator, thereby forming a heating and heat exchanging loop of the molten salt.

Optionally, the molten salt in the heat exchanging molten salt pipeline and the heating molten salt pipeline may be potassium nitrate, or a mixture of potassium nitrate and sodium nitrate, or a mixture of potassium nitrate, sodium nitrate and lithium nitrate.

Optionally, an injection device is also arranged between the vacuum cooling unit and the incinerating unit. The injection device includes a first injection inlet, a second injection inlet, a third injection inlet and an injection outlet. The first injection inlet is connected with the low-temperature gas outlet of the vacuum cooling unit. The second injection inlet is connected with the condensed water outlet of the vacuum cooling unit. The third injection inlet is connected with a gas storage tank which stores air. The injection outlet is connected with the incineration gas inlet of the incinerating unit.

The gas discharged from the mixed gas outlet of the vacuum heating unit is mixed gas of organic waste gas containing a little vapor. After being treated by the vacuum cooling unit, different amounts of organic waste gases, condensed waste water and air are injected respectively by the injection device into the incinerator for burning and decomposition.

Optionally, the cooling pipe of the vacuum cooling unit is spirally coiled in the cooling tank in the longitudinal direction.

Optionally, the vacuum heating unit includes a tank, a heating chamber that is disposed in the tank and is longitudinally coaxial with the tank, a gas-liquid separating device disposed in the tank and installed above the heating chamber, and a mixed gas outlet connected with the gas-liquid separating device and arranged on the top wall of the tank. The heating chamber includes an outer shell, an inner shell, a heating cavity arranged between the outer shell and the inner shell, a sludge inlet arranged at one side wall of the inner shell, a sludge outlet arranged at another side wall of the inner shell, a spiral compression device arranged in an inner cavity of the inner shell in a penetrating manner and corresponding to the sludge inlet and the sludge outlet respectively at both ends, a water inlet arranged at one side wall of the heating cavity, and a water outlet arranged at another side wall of the heating chamber. The top wall of the inner shell is connected with a plurality of gas discharging pipes going through the top wall of the outer shell and connected with the gas-liquid separating device. The water inlet is connected with the high-temperature liquid outlet of the molten salt heat exchanging unit.

In the vacuum heating unit, the sludge is disposed in the inner shell and squeezed by the spiral compression device to flow from the sludge inlet to the sludge outlet. The heating chamber is set at 2-10 atmosphere pressures. The hot water is set at 100° C.-180° C., for example, about 150° C. The heating chamber is set as vacuum, so that water in the sludge can be boiled into vapor at 40° C.-60° C., separated from the sludge and discharged to the vacuum heating unit from the gas discharging pipe. Thus, the hot water about 150° C. can be used to dry the sludge, thereby saving energy and reducing emission.

Optionally, the sludge inlet and the sludge outlet are provided with closed sealing covers (not shown in the drawing) respectively, so that when the system is started, vacuum can be formed in the heating chamber. When the system operates normally, the closed sealing covers are opened, and the sludge inlet and the sludge outlet are always filled fully with consecutive sludge, so that the interior of the heating chamber can always maintain vacuum.

Optionally, the circumferential wall of the inner shell is circumferentially provided with a number of inner bulges to increase the heated surface area of the sludge.

Optionally, the incinerator of the incinerating unit is provided with two flue gas discharge outlets and two combustion-supporting gas inlets. The incinerating unit further includes a first regenerator and a second regenerator. The first regenerator includes a first heat storage shell, a first port arranged at the inner side of the first heat storage shell and connected with one flue gas discharge outlet of the incinerator, a second port arranged at the inner side of the first heat storage shell and connected with one combustion-supporting inlet of the incinerator, a third port and a fourth port which are arranged at the outer side of the first heat storage shell, and the heat storage bodies arranged in the first heat storage shell. The second regenerator includes a second heat storage shell, a first port arranged at the inner side of the second heat storage shell and connected with another flue gas discharge port of the incinerator, a second port arranged at the inner side of the second heat storage shell and connected with another combustion-supporting gas inlet of the incinerator, a third port and a fourth port which are arranged at the outer side of the second heat storage shell, and the heat storage bodies arranged in the second heat storage shell. The third port of the first regenerator and the third port of the second regenerator are connected to a chimney respectively through a flue gas discharging pipeline. The fourth port of the first regenerator and the fourth port of the second regenerator are connected to an air source respectively through a pipeline.

Optionally, each port of the first regenerator and second regenerator is provided with a control valve respectively, so that the first regenerator and the second regenerator are controlled to be in a heat storage state and an operating state alternatively.

Tus, when the first regenerator is in the heat storage state and the second regenerator is in the operating state, the control valves of the first port and the third port of the first regenerator are opened, and the control valves of the second port and the fourth port of the first regenerator are closed, hence, hot flue gas enters the first regenerator to exchange heat with the heat storage bodies until the heat absorbed by the heat storage bodies reaches saturation. Then, the cooled cold flue gas is discharged from the fourth port. Correspondingly, the control valves of the second port and the fourth port of the second regenerator are opened, and the control valves of the first port and the third port of the second regenerator are closed, so that cold air enters the second regenerator from the fourth port, and hot air is formed after the cold air exchanges heat with the heat storage bodies and enters the incinerator of the incinerating unit from the second port, thereby effectively increasing the temperature in the incinerator and improving the incineration efficiency. When the temperature of the heat storage bodies in the first regenerator increases gradually to complete the heat storage work, the heat storage bodies in the second regenerator is cooled gradually, and after the amount of heat absorbed through heat exchanging by the air serving as the combustion-supporting gas is difficult to meet the preheating requirements, the control valves of the first port and the third port of the first regenerator are closed, and the control valves of the second port and the fourth port of the first regenerator are opened, so that the first regenerator is in the working state. Correspondingly, the control valves of the first port and the third port of the second regenerator are opened, and the control valves of the second port and the fourth port of the second regenerator are closed, so that the second regenerator is in a heat storage state.

Optionally, the first regenerator and the second regenerator are rotary waste heat collectors respectively and each includes an outer cylinder, a rotary heat storage disc which is coaxially arranged in the outer cylinder, a first spacer plate arranged at one side of the rotary heat storage disc, and a second spacer plate arranged at the other side of the rotary heat storage disc. The first spacer plate and the second spacer plate are disposed on the same longitudinal section of the outer cylinder. The front section of the outer cylinder is divided by the first spacer plate into a first flue gas flow passage and a first air flow passage. The rear section of the outer cylinder is divided by the second spacer plate into a second flue gas flow passage and a second air flow passage. A high-temperature flue gas inlet is formed at one end of the first flue gas flow passage away from the rotary heat storage disc. A flue gas outlet is formed at one end of the second flue gas flow passage away from the rotary heat storage disc. The high-temperature flue gas inlet is connected with the high-temperature flue gas outlet of the incinerator, and the flue gas outlet is connected to the chimney. An air inlet is formed at one end of the second air flow passage away from the rotary heat storage disc. A high-temperature air outlet is formed at one end of the first air flow passage away from the rotary heat storage disc. The air inlet is connected to the air source. The high-temperature air outlet is connected with the combustion-supporting gas inlet of the incinerator.

The rotary heat storage disc includes a porous bottom wall, a porous top wall, a circumferential side wall which extends from the periphery of the porous bottom wall to the periphery of the porous top wall, a central rotation shaft arranged along a longitudinal axis of the rotary heat storage disc, and at least eight baffles extending from the central rotation shaft to the circumferential side wall along the radial direction of the rotary heat storage disc. Heat exchanging bins for storing heat storage material are formed respectively among the porous bottom wall, the porous top wall, the circumferential side wall, the central rotation shaft and two adjacent baffles.

Optionally, one end of the first spacer plate adjacent to the rotary heat storage disc is close to the upper surface of the porous top wall of the rotary heat storage disc. One end of the second spacer plate adjacent to the rotary heat storage disc is close to the lower surface of the porous bottom wall of the rotary heat storage disc. The outer wall surface of the circumferential side wall of the rotary heat storage disc is close to the inner wall surface of the outer cylinder of the rotary waste heat collector.

Optionally, each heat exchanging bin can rotate successively at a constant speed from the flue gas flow passage to the air flow passage along the longitudinal axis of the outer barrel so as to absorb the waste heat of the high-temperature flue gas in the flue gas flow passage to heat the air in the air flow passage.

Optionally, the heat storage material stored in the heat exchanging bin may be ceramic balls, honeycomb regenerative bodies, composite heat storage materials, etc.

Optionally, the energy-saving sludge drying disposal system further includes a cooling tower. The cooling tower includes a tower body, and a cold air inlet, a hot air outlet, a low-temperature water outlet and a high-temperature water inlet which are arranged on the peripheral wall of the tower body. The high-temperature water inlet is connected with the water outlet of the vacuum heating unit. The low-temperature water outlet is connected with the low-temperature liquid inlet of the vacuum cooling unit. The cold air inlet is connected with the air source. The hot air outlet is connected with the fourth ports of the first regenerator and the second regenerator.

Optionally, the water outlet of the vacuum heating unit may be further provided with water discharging branch pipes which are used to convey part of hot water to the cooling tower to form water cycle. The other part of hot water is supplied to users for using.

Optionally, both the flue gas discharging pipeline between the third port of the first regenerator and the chimney and the flue gas discharging pipeline between the third port of the second regenerator and the chimney are provided with dust removal devices.

Tus, after the organic gas in the sludge is incinerated and decomposed, the high-temperature flue gas in the incinerator may heat the molten salt in the heating molten salt pipeline in the incinerator, and the hot molten salt flows back to the molten salt heat exchanging unit to exchange heat with medium-temperature water conveyed by the cooling tower. The formed high-temperature water is re-conveyed into the vacuum heating unit to dry the sludge, thereby recycling the energy.

Meanwhile, the flue gas discharged from the incinerator transfers the heat to the hot air conveyed by the cooling tower at the first regenerator or the second regenerator. The hot air is heated to 200-300° C. and then conveyed into the incinerator, thereby increasing the burning temperature of the incinerator and ensuring that the waste gas can be disposed by burning completely and thoroughly.

Optionally, the combustion-supporting gas inlet of the incinerating unit is provided with an air dispersion nozzle and the fuel oil inlet is provided with an oil burner, thereby increasing the burning efficiency of the incinerator, and ensuring that the waste gas can be disposed by burning completely and thoroughly.

Optionally, the molten salt heat exchanging unit further includes: a low-temperature gas inlet and a medium-temperature gas outlet which are arranged on the heat exchanging shell, and a heat exchanging gas pipeline arranged in the heat exchanging shell and connected between the low-temperature gas inlet and the medium-temperature gas outlet at both ends. The low-temperature gas inlet is connected with the air source. The medium-temperature gas outlet is connected with a gas storage tank.

Optionally, the low-temperature liquid inlet and the high-temperature liquid outlet of the vacuum cooling unit are provided with valves respectively.

Optionally, a pipeline between the cold molten salt outlet of the molten salt heat exchanging unit and the cold molten salt inlet of the incinerating unit is provided with a cold molten salt conveying pump. A pipeline between the hot molten salt inlet of the molten salt heat exchanging unit and the hot molten salt outlet of the incinerating unit is provided with a hot molten salt conveying pump.

The present invention has the beneficial effects that: (1) the sludge is dried at a low temperature in a vacuum state in the vacuum heating unit, so that the consumption of heat energy and discharge amount of waste gas can be effectively reduced; (2) the vacuum cooling unit can separate the vapor from the gas discharged in the sludge drying process to form condensed water and organic waste gases; the organic waste gases and the condensed water are conveyed to the incinerating unit for burning; In the incinerating unit, the waste gases in the sludge are decomposed and purified completely, thereby ensuring that the discharged gas meets the environmental discharge standard; (3) the molten salt heat exchanging unit is used to exchange the heat produced by the burning of the organic waste gases with the medium-temperature water discharged from the vacuum cooling unit to form vapor which is conveyed to the vacuum heating unit to dry the sludge, thereby realizing the self-sufficient in the energy supply and increasing the utilization rate of the energy; and (4) the heat of the flue gas discharged from the incinerating unit can be used fully to preheat the combustion-supporting gas and to guarantee the temperature stability in the incinerator, thereby increasing the burning efficiency of the waste gas in the incinerator, guaranteeing the thorough burning of the waste gas, meeting the environmental discharge standard, making full use of the energy, and making the entire sludge disposal system more energy-saving and environment-friendly.

### DESCRIPTION OF THE DRAWINGS

FIG. 1 is a structural schematic diagram of an energy-saving sludge drying disposal system of the present invention; and

FIG. 2 is a sectional structural schematic diagram of a vacuum heating unit of the present invention.

### DETAILED DESCRIPTION OF PREFERRED EMBODIMENTS

Embodiments of the present disclosure are described below in detail. Examples of the embodiments are shown in the accompanying drawings, wherein same or similar reference numerals always indicate the same or similar elements or elements having the same or similar functions. The embodiments described below with reference to the drawings are exemplary and are intended to explain the present invention, but should not be construed as limiting the present invention.

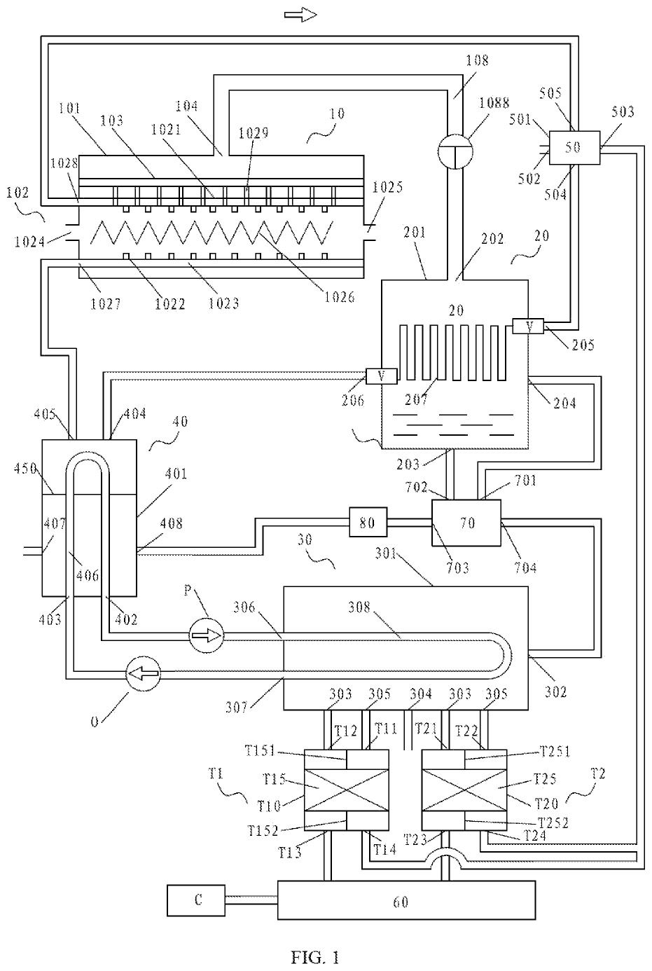

Referring to FIG. 1, according to a nonrestrictive implementation of the present invention, the energy-saving sludge drying disposal system includes a vacuum heating unit 10, a vacuum cooling unit 20, an incinerating unit 30, a molten salt heat exchanging unit 40 and a cooling tower 50.

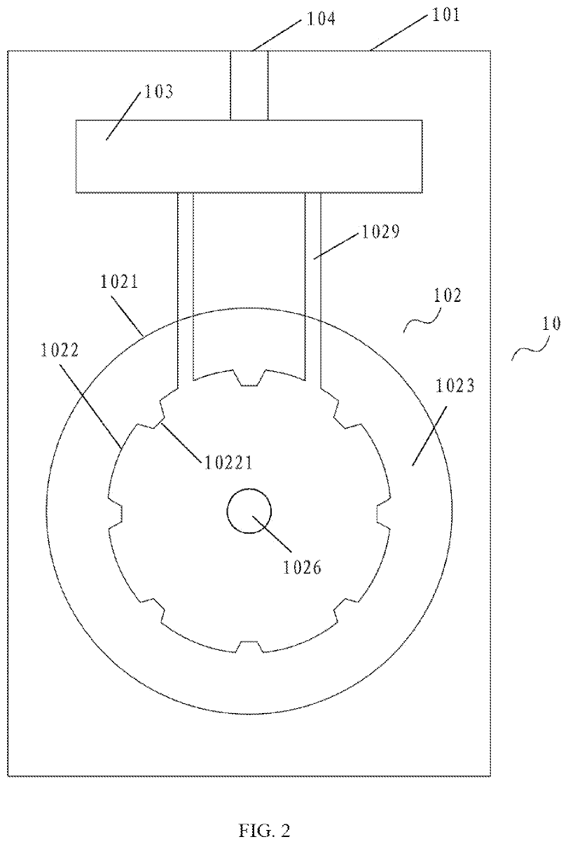

Referring to FIG. 1 and FIG. 2, the vacuum heating unit 10 includes a tank 101, a heating chamber 102, a gas-liquid separating device 103 and a mixed gas outlet 104. The heating chamber 102 includes an outer shell 1021, an inner shell 1022, a heating cavity 1023, a sludge inlet 1024, a sludge outlet 1025, a spiral compression device 1026, a water inlet 1027, a water outlet 1028 and a gas discharging pipe 1029. The peripheral wall of the inner shell 1022 is circumferentially provided with a multiple inner bulges 10221, so that the heated surface area of the sludge can be increased.

The vacuum cooling unit 20 includes a cooling tank 201, a high-temperature gas inlet 202, a condensed water outlet 203, a low-temperature gas outlet 204, a low-temperature liquid inlet 205, a medium-temperature liquid outlet 206 and a cooling pipe 207. The cooling pipe 207 is spirally coiled in the cooling tank 201 in the longitudinal direction. The high-temperature gas inlet 202 of the vacuum cooling unit 20 is connected with the mixed gas outlet 104 of the vacuum heating unit 10 through a conveying pipeline 108, and the conveying pipeline 108 is provided with a vacuum pump 1088.

The incinerating unit 30 includes an incinerator 301, and an incineration gas inlet 302, a combustion-supporting air inlet 305, a fuel inlet 304, a flue gas discharge outlet 303, a cold molten salt inlet 306 and a hot molten salt outlet 307 which are provided successively on the wall of the incinerator 301, and a heating molten salt pipeline 308 arranged in the incinerator 301 and connected to the cold molten salt inlet 306 and the hot molten salt outlet 307 respectively at both ends. The incineration gas inlet 302 is connected with the low-temperature gas outlet 204 of the vacuum cooling unit 20.

The molten salt heat exchanging unit 40 includes a heat exchanger shell 401, a cold molten salt outlet 402, a hot molten salt inlet 403, a medium-temperature liquid inlet 404, a high-temperature liquid outlet 405, a heat exchanging molten salt pipeline 406, a heat exchanging water pipeline (not shown) and an electric heating device (not shown). The cold molten salt outlet 402 is connected with the cold molten salt inlet 306 of the incinerating unit 30. The hot molten salt inlet 403 is connected with the hot molten salt outlet 307 of the incinerating unit 30. The medium-temperature liquid inlet 404 is connected with the medium-temperature liquid outlet 206 of the vacuum cooling unit 20. The high-temperature liquid outlet 405 is connected with the water inlet 1027 of the vacuum heating unit 10.

As another non-limiting implementation, the incinerating unit 30 further includes a first regenerator T1 and a second regenerator T2. As shown in FIG. 1, the incinerator 301 of the incinerating unit 30 is provided with two flue gas discharge outlets 303 and two combustion-supporting air inlets 305.

The first regenerator T1 includes a first heat storage shell T10, a first port T11, a second port T12, a third port T13, a fourth port T14 and a rotary heat storage disc T15. The second regenerator T2 includes a second heat storage shell T20, a first port T21, a second port T22, a third port T23, a fourth port T24 and a rotary heat storage disc T25. The third port T13 of the first regenerator T1 and the third port T23 of the second regenerator T2 are connected to a chimney C respectively through a flue gas discharging pipeline.

Specifically, the first regenerator T1 is a rotary waste heat collector, and includes an outer cylinder T10, the rotary heat storage disc T15 which is arranged in the outer cylinder coaxially with the outer cylinder, a first spacer baffle T151 arranged at one side of the rotary heat storage disc, and a second spacer baffle T152 arranged at the other side of the rotary heat storage disc. The second regenerator T2 is also a rotary waste heat collector, and includes an outer cylinder T20, the rotary heat storage disc T25 which is arranged in the outer cylinder coaxially with the outer cylinder, a first spacer baffle T251 arranged at one side of the rotary heat storage disc, and a second spacer baffle T252 arranged at the other side of the rotary heat storage disc.

Taking the first regenerator T1 as an example, the first spacer baffle T151 and the second spacer baffle T152 are provided on the same longitudinal section of the outer cylinder. A front section of the outer cylinder is divided by the first spacer baffle into a first flue gas flow passage and a first air flow passage. A rear section of the outer barrel is divided by the second spacer plate into a second flue gas flow passage and a second air flow passage. A high-temperature flue gas inlet T12 is formed at one end of the first flue gas flow passage away from the rotary heat storage disc. A flue gas outlet T13 is formed at one end of the second flue gas flow passage away from the rotary heat storage disc. The high-temperature flue gas inlet is connected with one flue gas outlet 303 of the incinerator 301, and the flue gas outlet T13 is connected to the chimney C. An air inlet T14 is formed at one end of the second air flow passage away from the rotary heat storage disc T15. A high-temperature air outlet T1 is formed at one end of the first air flow passage away from the rotary heat storage disc. The air inlet T14 is connected to the air source through a pipeline. The high-temperature air outlet T11 is connected with one combustion-supporting air inlet 305 of the incinerator 301.

In the non-limiting implementation, to protect the environment and prevent substances that pollute the air from appearing in the flue gas, a flue gas discharging pipeline between the third port T13 of the first regenerator T1 and the chimney C and a flue gas discharging pipeline between the third port T23 of the second regenerator T2 and the chimney C are provided with dust removal device 60. The dust removal devices 60 is used to filter and purify the discharged flue gas, so that the flue gas meets the discharge standard, and the temperature of the discharged flue gas is about 200° C.

As another nonrestrictive implementation, the energy-saving sludge drying disposal system further includes a cooling tower 50. As shown in FIG. 1, the cooling tower 50 includes a tower body 501, and a cold air inlet 502, a hot air outlet 503, a low-temperature water outlet 504 and a high-temperature water inlet 505 which are arranged on the circumferential wall of the tower body 501. The high-temperature water inlet 505 is connected with the water outlet 1028 of the vacuum heating unit 10. The low-temperature water outlet 504 is connected with the low-temperature liquid inlet 205 of the vacuum cooling unit 20. The cold air inlet 502 is connected with the air source. The hot air outlet 503 is connected with the fourth port T14 of the first regenerator T1 and the fourth port T24 of the second regenerator T2.

As a further nonrestrictive implementation, an injection device 70 is also arranged between the vacuum cooling unit 20 and the incinerating unit 30. The injection device 70 includes a first injection inlet 701, a second injection inlet 702, a third injection inlet 703 and an injection outlet 704. The first injection inlet 701 is connected with the low-temperature gas outlet 204 of the vacuum cooling unit 20. The second injection inlet 702 is connected with the condensed water outlet 203 of the vacuum cooling unit 20. The third injection inlet 703 is connected with a gas storage tank 80 which stores compressed air. The injection outlet 704 is connected with the incineration gas inlet 302 of the incinerating unit 30.

Furthermore, as shown in FIG. 1, the molten salt heat exchanging unit 40 further includes a low-temperature gas inlet 407 and a medium-temperature gas outlet 408 which are arranged on the heat exchanger shell 401, and a heat exchanging gas pipeline (not shown). The low-temperature gas inlet 407 is connected with a compressed air source. The medium-temperature gas outlet 408 is connected with the gas storage tank 80. Further, a spacer baffle 450 is provided to divide the interior of the heat exchanger shell 401 into an upper water heat exchanging space and a lower air heat exchanging space (the top and bottom directions shown in the drawing are only exemplary).

To realize the smooth flow of the molten salt, the pipeline between the cold molten salt outlet 402 of the molten salt heat exchanging unit 40 and the cold molten salt inlet 306 of the incinerating unit 30 is provided with a cold molten salt conveying pump P. The pipeline between the hot molten salt inlet 403 of the molten salt heat exchanging unit 40 and the hot molten salt outlet 307 of the incinerating unit 30 is provided with a hot molten salt conveying pump O.

Tus, the sludge is first disposed in the inner shell 1022 of the vacuum heating unit 10 and flows from the sludge inlet 1024 to the sludge outlet 1025 under the squeezing action of the spiral compression device 1026. The heating cavity 1023 is set at 2-10 atmosphere pressures. The temperature of the hot water entering from the water inlet 1027 is set at 100° C.-180° C. Due to the vacuum state, the water in the sludge can be boiled into vapor at 40° C.-60° C., separated from the sludge, discharged out of the vacuum heating unit 10 from the gas discharging pipe 1029 and enters the vacuum cooling unit 20. The dried sludge is discharged from the sludge outlet 1025.

The high-temperature gas enters the vacuum cooling unit 20 from the high-temperature gas inlet 202 and is cooled by the cold water delivered by the cooling tower 50. Then the formed low-temperature gas and the condensate water are conveyed by the injection pump 70 from the low-temperature gas outlet 204 into the incineration unit 30 for burning to eliminate toxic substances in the waste gas.

The heat produced in the burning process of the gas heats the molten salt in the heating molten salt pipeline 308 in the incinerator 301. Then the hot molten salt enters the molten salt heat exchanging unit 40 from the hot molten salt outlet 307 to exchange heat with the medium-temperature water conveyed by the cooling tower 50. The formed high-temperature water is conveyed into the vacuum heating unit 10 through the high-temperature liquid outlet 405 to dry the sludge, thereby recycling the energy.

At the same time, the flue gas discharged from the incinerator 301 transfers the heat to the hot air conveyed by the cooling tower 50 through the first regenerator T1 and the second regenerator 2. The hot air is heated to high-temperature air whose temperature is 700-900° C., and then conveyed into the incinerator 301, thereby increasing the burning temperature of the incinerator, stabilizing the burning temperature in the incinerator, and ensuring that the waste gas can be burned completely and thoroughly.

In the illustration of the present invention, the illustration with reference to terms “one embodiment”, “some embodiments”, “examples”, “specific examples”, or “some examples” etc. mean that specific features, structures or characteristics illustrated in conjunction with the embodiments or examples are included in at least one embodiment or example of the present invention. In the description, the schematic representations of the above terms are not necessary used for the same embodiment or example. Furthermore, different embodiments or examples and features of different embodiments or examples illustrated in the description may be integrated and combined by those skilled in the art without contradicting each other.

Although the embodiments of the present invention have been shown and described above, it may be understood that the above embodiments are exemplary and shall not be construed as limiting the present invention. Changes, modifications, replacements and variations may be made by those ordinary skilled in the art for the above embodiments within the scope of the present invention.

We claim:

1. An energy-saving sludge drying disposal system, comprising: a vacuum heating unit and an incinerating unit, and further comprising a vacuum cooling unit and a molten salt heat exchanging unit;
wherein the vacuum heating unit comprises a tank, a heating chamber provided in the tank and longitudinally coaxial with the tank, a gas-liquid separating device provided in the tank and arranged above the heating chamber, and a mixed gas outlet connected with the gas-liquid separating device and arranged on the top wall of the tank; the heating chamber comprises an outer shell, an inner shell, a heating cavity provided between the outer shell and the inner shell, a sludge inlet provided at one side wall of the inner shell, a sludge outlet provided at another side wall of the inner shell, a spiral compression device provided in an inner cavity of the inner shell in a penetrating manner and corresponding to the sludge inlet and the sludge outlet respectively at both ends, a water inlet provided at one side wall of the heating chamber, and a water outlet provided at another side wall of the heating chamber, a top wall of the inner shell is connected with several gas discharging pipes going through the top wall of the outer shell and connected with the gas-liquid separating device; and the water inlet is connected with the high-temperature liquid outlet of the molten salt heat exchanging unit;
the vacuum cooling unit comprises a cooling tank, a high-temperature gas inlet provided at the top wall of the cooling tank, a condensed water outlet provided at the bottom wall of the cooling tank, a low-temperature gas outlet and a low-temperature liquid inlet provided at one side of the cooling tank, a medium-temperature liquid outlet provided at the other side of the cooling tank, and a cooling pipe provided in the cooling tank and connected respectively between the low-temperature liquid inlet and the medium-temperature liquid outlet at both ends; the high-temperature gas inlet of the vacuum cooling unit is connected with a mixed gas outlet of the vacuum heating unit;
the incinerating unit comprises an incinerator, and an incineration gas inlet, a combustion-supporting gas inlet, a fuel oil inlet, a flue gas discharge outlet, a cold molten salt inlet and a hot molten salt outlet provided in sequence on a wall of the incinerator, and a heating molten salt pipeline arranged in the incinerator and connected to the cold molten salt inlet and the hot molten salt outlet respectively at both ends; the incineration gas inlet is connected with the low-temperature gas outlet of the vacuum cooling unit;
the molten salt heat exchanging unit comprises a heat exchanger shell, and a cold molten salt outlet, a hot molten salt inlet, a medium-temperature liquid inlet and a high-temperature liquid outlet provided on the heat exchanger shell, a heat exchanging molten salt pipeline arranged in the heat exchanger shell and connected between the cold molten salt outlet and the hot molten salt inlet at both ends; the cold molten salt outlet is connected with the cold molten salt inlet of the incinerating unit, and the hot molten salt inlet is connected with the hot molten salt outlet of the incinerating unit; the medium-temperature liquid inlet is connected with the medium-temperature liquid outlet of the vacuum cooling unit, and the high-temperature liquid outlet is connected with the vacuum heating unit.

2. The energy-saving sludge drying disposal system of claim 1, wherein the cooling pipe of the vacuum cooling unit is spirally coiled in the cooling tank in a longitudinal direction.

3. The energy-saving sludge drying disposal system of claim 1, wherein an injection device is provided between the vacuum cooling unit and the incinerating unit; the injection device comprises a first injection inlet, a second injection inlet, a third injection inlet and an injection outlet; the first injection inlet is connected with the low-temperature gas outlet of the vacuum cooling unit; the second injection inlet is connected with the condensed water outlet of the vacuum cooling unit; the third injection inlet is connected with a gas storage tank which stores air, and the injection outlet is connected with the incineration gas inlet of the incinerating unit.

4. The energy-saving sludge drying disposal system of claim 1, wherein a peripheral wall of the inner shell is circumferentially provided with a plurality of inner bulges to increase a heated surface area of the sludge.

5. The energy-saving sludge drying disposal system of claim 1, wherein the incinerator of the incinerating unit is provided with two flue gas discharge outlets and two combustion-supporting gas inlets; the incinerating unit further comprises a first regenerator and a second regenerator;
the first regenerator comprises a first heat storage shell, a first port provided at an inner side of the first heat storage shell and connected with one flue gas discharge outlet of the incinerator, a second port arranged at the inner side of the first heat storage shell and connected with one combustion-supporting inlet of the incinerator, a third port and a fourth port provided at an outer side of the first heat storage shell, and a rotary heat storage disc arranged in the first heat storage shell
the second regenerator comprises a second heat storage shell, a first port arranged at the inner side of the second heat storage shell and connected with another flue gas discharge port of the incinerator, a second port provided at the inner side of the second heat storage shell and connected with another combustion-supporting gas inlet of the incinerator, a third port and a fourth port provided at the outer side of the second heat storage shell, and a rotary heat storage disc provided in the second heat storage shell;
the third port of the first regenerator and the third port of the second regenerator are connected to a chimney respectively through a flue gas discharging pipeline; and the fourth port of the first regenerator and the fourth port of the second regenerator are connected to an air source respectively through a pipeline.

6. The energy-saving sludge drying disposal system of claim 5, wherein the energy-saving sludge drying disposal system further comprises a cooling tower; the cooling tower comprises a tower body, and a cold air inlet, a hot air outlet, a low-temperature water outlet and a high-temperature water inlet provided on a peripheral wall of the tower body; the high-temperature water inlet is connected with the water outlet of the vacuum heating unit; the low-temperature water outlet is connected with the low-temperature liquid inlet of the vacuum cooling unit; the cold air inlet is connected with the air source; and the hot air outlet is connected with the fourth ports of the first regenerator and the second regenerator.

7. The energy-saving sludge drying disposal system of claim 5, wherein a flue gas discharging pipeline between the third port of the first regenerator and the chimney and a flue gas discharging pipeline between the third port of the second regenerator and the chimney are provided with dust removal devices.

8. The energy-saving sludge drying disposal system of claim 7, wherein the molten salt heat exchanging unit further comprises: a low-temperature gas inlet and a medium-temperature gas outlet provided on the heat exchanger shell, and a heat exchanging gas pipeline provided in the heat exchanger shell and connected between the low-temperature gas inlet and the medium-temperature gas outlet at both ends, wherein the low-temperature gas inlet is connected with the air source, and the medium-temperature gas outlet is connected with a gas storage tank.

9. The energy-saving sludge drying disposal system of claim 1, wherein a pipeline between the cold molten salt outlet of the molten salt heat exchanging unit and the cold molten salt inlet of the incinerating unit is provided with a cold molten salt conveying pump; and a pipeline between the hot molten salt inlet of the molten salt heat exchanging unit and the hot molten salt outlet of the incinerating unit is provided with a hot molten salt conveying pump.
